(19) United States
(12) Patent Application Publication
(10) Pub. No.: US 2007/0207942 A1
(43) Pub. Date: Sep. 6, 2007

(54) Controlled Release Compositions

(76) Inventors: Serge Creutz, Rocourt (BE); Houria Seghir, Nivelles (BE)

Correspondence Address: DOW CORNING CORPORATION CO1232, 2200 W. SALZBURG ROAD, P.O. BOX 994, MIDLAND, MI, 48686-0994, US

(21) Appl. No.: 10/590,952

(22) PCT Filed: Feb. 25, 2005
(86) PCT No.: PCT/US05/06501

§ 371 Date: Aug. 28, 2006

(30) Foreign Application Priority Data
Mar. 26, 2004 (GB) 0406819.3

(51) Int. Cl. A61Q 13/00

(52) U.S. Cl. 512/2

(57) ABSTRACT

A composition for controlling the release of an active material, such as fragrances, sunscreens, vitamins, drugs, biocides, pest repellents, catalysts and cooling agents, from a cleaning composition, personal care product, household care product or textile treatment composition, comprising a blend of the active material and a waxy silicone material. The invention is characterized in that the blend of active material and waxy silicone material is present as the disperse phase of an oil-in-water emulsion comprising a cationic surfactant which is an esterquat quaternary ammonium material containing at least one ester linking group in the quaternary ammonium molecule or a cationic surfactant which is a quaternary ammonium material containing at least two alkyl chains each having at least 12 carbon atoms.

This invention relates to compositions and processes for the controlled release of active materials suitable for incorporation in personal care products such as hair shampoos and soaps and shower gels for personal washing, in other personal care products such as antiperspirants or deodorants, in cleaning compositions such as laundry detergents, hard surface cleaners or wiping cloths, in other household care products such as polishes or air fresheners, or in textile treatment compositions such as fabric softeners or tumble drier sheets.

One type of active material for which controlled release is desired is a fragrance composition. Fragrances are frequently incorporated in detergents and other cleaning products to give a pleasant odor during use of the cleaning product and to mask the inherent smell of the soap or other surfactant present in the cleaning product. The fragrances are generally complex mixtures of fragrant compounds of varying volatility. Upon storage in a cleaning composition, perfumes and fragrances can be altered through interactions and/or reactions with the other components of the composition. Due to their volatile nature, the fragrant compounds tend to be dissipated with time, particularly the most volatile compounds which are often associated with perceived freshness. Moreover, when used, such as during washing of fabrics with a laundry detergent, most of the perfume is also lost in the aqueous phase during the washing cycle. It has been recognized as desirable that the fragrance should survive storage in the cleaning composition and also survive the cleaning process and should be deposited on the fabric, so that fabrics laundered with a detergent containing the fragrance should have the pleasant odor of the fragrance.

Furthermore, once adsorbed onto the targeted surface, for example fabrics or hair or skin, the fragrance tends to be dissipated very quickly. There is thus a need to improve the storage stability of perfumes and fragrances, their delivery in the application and their long-lasting effect through sustained delayed release once applied on fabrics.

Various methods of protecting the fragrance composition have been proposed. The perfume may be mixed with a porous carrier such as zeolite and then coated with a protective barrier, for example a sugar derivative before incorporation in a laundry detergent as described in WO98/41607. U.S. Pat. No. 4,973,422 describes encapsulating perfume particles with a pH sensitive coating comprising an acrylic resin and cellulose esters. WO-A-98/28936 describes mixing the perfume with an aqueous slurry of polymer beads made of hydrophobic polyacrylate; polyvinyl alcohol can be adsorbed at the surface of the beads to improve deposition. WO-A-00/02981 describes reacting a perfume component with an amine to obtain a release of the active component over a longer period of time.

U.S. Pat. No. 6,050,129 relates to a process for testing diffusivity, odor character and odor intensity of a fragrance material used in an air freshener and describes mixing perfume with a hydrophobic wax such as candelilla wax or carnauba wax and emulsifying the blend in water, preferably with cationic surfactants, to form a long lasting fragrance composition for use in a hair care composition such as a shampoo/conditioner.

WO-A-01/25389 describes a domestic care product comprising a fragrance particle. The particle comprises a fragrance composition and a waxy silicone polymer having a melting point of at least 10° C. At least 20% of the silicone atoms in the silicone polymer have a substituent of 16 carbon atoms or more. WO-A-03/082356 proposes an improvement whereby the fragrance composition and the waxy silicone are dispersed in a continuous phase comprising an aqueous solution of concentration at least 0.1 molar of a salt capable of ionic disassociation in water to form an emulsion.

According to the present invention a composition for controlling the release of an active material, selected from fragrances, sunscreens, vitamins, drugs, biocides, pest repellents, catalysts and cooling agents, from a cleaning composition, personal care product, household care product or textile treatment composition, comprises a blend of the active material and a waxy silicone material, characterized in that the blend of active material and waxy silicone material is present as the disperse phase of an oil-in-water emulsion comprising a cationic surfactant which is an esterquat quaternary ammonium material containing at least one ester linking group in the quaternary ammonium molecule or a cationic surfactant which is a quaternary ammonium material containing at least two alkyl chains each having at least 12 carbon atoms.

In a process according to the invention for controlling the release of an active material, selected from fragrances, sunscreens, vitamins, drugs, biocides, pest repellents, catalysts and cooling agents, from a cleaning composition, personal care product, household care product or textile treatment composition by blending the active material and a waxy silicone material before adding the active material to the cleaning composition, personal care product, household care product or textile treatment composition, the waxy silicone material and the active material are emulsified with water and a cationic surfactant which is an esterquat quaternary ammonium material containing at least one ester linking group in the quaternary ammonium molecule or a cationic surfactant which is a quaternary ammonium material containing at least two alkyl chains each having at least 12 carbon atoms to form an oil-in-water emulsion.

One example of an active material is a fragrance composition. The fragrance composition may be solid or liquid and may be a single fragrant compound, or a natural scented oil, or may be a mixture of fragrant compounds and/or natural oils. Examples of such natural oils and fragrant compounds are described in WO-A-01/25389; these natural oils and fragrant compounds are in particular those suitable for use in cleaning compositions for household or personal use, or for air fresheners. The fragrance composition may be a perfume for incorporation in a personal care product such as a skin cream, shampoo or face cream, or may be a flavor or aroma compound to be applied for example to food or food packaging. Flavor compounds, for example fruit flavors such as strawberry essence, can also be applied to toys or other objects. The fragrance composition can alternatively comprise a chemically protected fragrance compound such as a reaction product of the fragrance compound.

An alternative type of active material which can be incorporated in the controlled release composition is a sunscreen composition. Examples of sunscreens include those which absorb ultraviolet light between about 290-320 nanometers (the UV-B region) such as para-aminobenzoic acid derivatives and cinnamates such as octyl methoxycinnamate or 2-ethoxyethyl p-methoxycinnamate; and those which absorb ultraviolet light in the range of 320-400 nanometers (the UV-A region) such is benzophenones and butyl methoxy dibenzoylmethane. Additional examples of sunscreen chemicals which may be used as active material in the present invention include menthyl anthranilate; homomenthyl salicylate; glyceryl p-aminobenzoate; isobutyl p-aminobenzoate; isoamyl p-dimethylaminobenzoate; 2,2′-dihydroxy-4-methoxybenzophenone; 2-hydroxy-4-methoxybenzophenone; 4-mono and 4-bis(3-hydroxy-propyl)amino isomers of ethyl benzoate; and 2-ethylhexyl p-dimethylaminobenzoate. The invention is particularly applicable to lipophilic screening agents, including the family of screening agents derived from dibenzoylmethane and more especially 4-tert-butyl-4′-methoxydibenzoylmethane, which effectively have a high intrinsic power of absorption. These dibenzoylmethane derivatives are well known as UV-A active screening agents and are described in particular in European patent application EP-A-0,114,607. 4-(tert-butyl)-4′-methoxydibenzoylmethane is sold under the trade mark “Parsol 1789” by Givaudan. Another dibenzoylmethane derivative which is preferred according to the present invention is 4-isopropyldibenzoylmethane, sold under the name “Eusolex 8020” by Merck. Octocrylene, a liquid lipophilic screening agent known for its activity in the UV-B range and sold under the trade mark “Uvinul N 539” by BASF. Another lipophilic (or liposoluble) screening agent which can be used in the invention is p-methylbenzylidenecamphor, which is known as a UV-B absorber and is sold under the trade name “Eusolex 6300” by Merck. The sunscreen can alternatively be a hydrophilic screening agent, for example one or more of those described in Application EP-A-678,292, particularly a 3-benzylidine-2-camphorsulphonic derivative such as benzene-1,4-[di(3-methylidenecamphor-10-sulphonic acid)], known under the trade name Mexoryl SX, or a sulphonic derivative of benzophenone or 2-phenylbenzimidazole-5-sulphonic acid, for example that sold under the trade mark “Eusolex 232” by Merck, benzene-1,4-di(benzimidazol-2-yl-5-sulphonic acid) or benzene-1,4-di(benzoxazol-2-yl-5-sulphonic acid).

An alternative type of active material which can be incorporated in the controlled release composition is a vitamin composition. Vitamins are a class of organic compounds that must be ingested part of the diet for humans (and other organisms) in order to maintain health and well being. Some vitamins also have beneficial effects when applied topically and for this reason are popular ingredients in various personal care formulations, where it is desired that the vitamin should be released gradually after the formulation has been applied to the skin or hair.

Vitamins comprise a variety of different organic compounds such as alcohols, acids, sterols, and quinones. They can be classified into two solubility groups: lipid-soluble vitamins and water-soluble vitamins. Lipid-soluble vitamins that have utility in personal care formulations include retinol (vitamin A), ergocalciferol (vitamin D₂), cholecalciferol (vitamin D₃), phytonadione (vitamin K₁), and tocopherol (vitamin E). Water-soluble vitamins that have utility in personal care formulations include ascorbic acid (vitamin C), thiamin (vitamin B₁) niacin (nicotinic acid), niacinamide (vitamin B₃), riboflavin (vitamin B₂), pantothenic acid (vitamin B₅), biotin, folic acid, pyridoxine (vitamin B₆), and cyanocobalamin (vitamin B₁₂). The present invention is particularly useful in giving controlled release of lipid-soluble vitamins but can also give controlled release of some water-soluble vitamins. Examples of vitamins which have been blended with a waxy polysiloxane to give controlled release are vitamins A and E.

Many of the vitamins that are used in personal care compositions are inherently unstable and therefore present difficulties in the preparation of shelf-stable personal care compositions. The instability of the vitamins is usually related to their susceptibility to oxidation. For this reason, vitamins are often converted into various derivatives that are more stable in personal care formulations. These vitamin derivatives offer other advantages in addition to improved stability. Vitamin derivatives can be more amenable to certain kinds of personal care formulations. For example a lipid-soluble vitamin can be derivatized to produce a water-soluble material that is easier to incorporate into a water-based formulation. Retinol and tocopherol are two lipid-soluble vitamins that are particularly useful in skin care compositions and consequently there are many different derivatives of these two vitamins that are used in personal care compositions. Derivatives of retinol include retinyl palmitate (vitamin A palmitate), retinyl acetate (vitamin A acetate), retinyl linoleate (vitamin A linoelate), and retinyl propionate (vitamin A propioniate). Derivatives of tocopherol include tocopheryl acetate (vitamin E acetate), tocopheryl linoleate (vitamin E linoleate), tocopheryl succinate (vitamin E succinate), tocophereth-5, tocophereth-10, tocophereth-12, tocophereth-18, tocophereth-50 (ethoxlyated vitamin E derivatives), PPG-2 tocophereth-5, PPG-5 tocophereth-2, PPG-10 tocophereth-30, PPG-20 tocophereth-50, PPG-30 tocophereth-70, PPG-70 tocophereth-100 (propoxylated and ethoxylated vitamin E derivatives), and sodium tocopheryl phosphate. The invention can be used to give controlled release of these vitamin derivatives. Derivatives of ascorbic acid (Vitamin C) such as ascorbyl palmitate, ascorbyl dipalmitate, ascorbyl glucoside, ascorbyl tetraisopalmitate, and tetrahexadecyl ascorbate can also be used as the active material, as can vitamin derivatives incorporating two different vitamins in the same compound, for example ascorbyl tocopheryl maleate, potassium ascorbyl tocopheryl phosphate or tocopheryl nicotinate.

A further alternative type of active material which can be incorporated in the controlled release composition is a biocide, for example to give prolonged protection of a composition against bacterial degradation or to give a prolonged biocidal effect to a substrate to which the composition has been applied. The active material can also be a pest repellent, for example an insect repellent, or a repellent for rodents, or a repellent for any animal including cats or dogs. Insect repellent personal care products can for example be in the form of creams, sticks or sprays, and controlled release of the insect repellent from the personal care product is required after the product has been applied to the skin.

A further alternative type of active material which can be incorporated in the controlled release composition is a catalyst, for example a curing catalyst in coatings or adhesives where controlled release is advantageous to give thorough cure without curing too rapidly. One example of such a catalyst is a fatty amine to be used as curing agent for an epoxy resin composition.

The invention can also be used to give controlled release of a cooling agent (a material which gives a cooling sensation to the skin) such as menthol or other cooling agents described in WO96/19119. The blend of cooling agent and waxy polysiloxane material can be incorporated in a skin care composition to give prolonged release of the cooling agent when the composition is rubbed into the skin. The invention can also be used to give controlled release of a drug (a pharmaceutically active material) from a composition which is applied to the skin to dose the drug by transdermal delivery.

The invention is particularly applicable to hydrophobic lipophilic active materials, since these are more readily miscible with the waxy silicones and are less readily released from blends with waxy silicones, but the invention is also effective in giving controlled release of hydrophilic active materials provided these are not so hydrophilic that they have a high solubility in water.

The waxy silicone material is preferably a polysiloxane containing hydrocarbon substituents having 12 or more carbon atoms. The polysiloxane is preferably a polydiorganosiloxane comprising methyl alkyl siloxane units ((CH3)(R′)SiO2/2), where R′ is a long chain alkyl group having 12 or more, preferably 16 to 100 carbon atoms, optionally together with dimethyl siloxane units or units of the formula ((CH₃)(R″)SiO_{2/2}) where R″ is an alkyl group having 1-11 carbon atoms, for example ethyl, a cycloalkyl group such as 2-cyclohexylethyl, a haloalkyl group, an aryl group such as phenyl or an aralkyl group such as 2-phenylpropyl, 2-phenylethyl or 2-(t-butylphenylethyl). The methyl group of the above siloxane units could be replaced by ethyl or another lower alkyl group if desired. The long chain alkyl group R′ can optionally be substituted by polar substituents such as amino, amido, alcohol, alkoxy, or ester groups. Preferably at least 20% of the silicon atoms in the polysiloxane, and most preferably at least 50%, have an alkyl substituent having 16 to 100 carbon atoms, most preferably 20 to 45 carbon atoms, particularly 26 to 30 carbon atoms. The polysiloxane may be linear or may be branched, for example it may contain CH3SiO3/2 units or R′SiO_{3/2} units. Alternatively the polysiloxane can be cyclic, for example a cyclopolysiloxane containing 4 or 5 methyl alkyl siloxane units in which the said alkyl group has 16 to 100, most preferably 20 to 36, carbon atoms. Blends of waxy silicones can be used, for example a blend of a waxy cyclopolysiloxane with a linear waxy silicone. The waxy silicone preferably has a melting point in the range 10-200° C., most preferably 30 to 80° C.

The waxy polysiloxane can be blended with an organic (non-silicon-containing) wax, for example microcrystalline wax, paraffin wax or a mixture thereof, a long chain fatty acid or a waxy ester thereof such as a triglyceride, or a long chain fatty alcohol, fatty amine, fatty amide, ethoxylated fatty acid or fatty alcohol, a long chain alkyl phenol or polyethylene wax.

The waxy silicone can be mixed with a liquid silicone, for example a polydiorganosiloxane, a branched liquid polysiloxane, a silicone polyether copolymer or an aminopolysiloxane. Particularly preferred liquid polysiloxanes are those containing aryl, for example phenyl, or aralkyl, for example benzyl, 2-phenylethyl or 2-phenylpropyl groups in addition to alkyl groups such as methyl. The liquid polydiorganosiloxane can be linear or cyclic; cyclic siloxanes such as tetra(2-phenylpropyl)tetramethylcyclotetrasiloxane may be preferred. The liquid polysiloxane can contain functional groups, for example it can contain hydroxyl groups such as terminal silanol groups in a linear polydiorganosiloxane such as polydimethylsiloxane, alkoxy groups such as methoxy, ethoxy or propoxy bonded to silicon, or amino, amido, alcohol or alkoxy groups substituted in an organic group bonded to silicon. The waxy hydrophobic mixture of the waxy polysiloxane and the liquid silicone is preferably a solid, for example it preferably has a melting point in the range 10-200° C., but can alternatively be a viscous liquid. The liquid silicone can for example be used at up to 100% or even higher based on the weight of the wax, such as up to 200 or 300%, particularly if the blend of wax and liquid silicone is solid at 10° C., although the liquid silicone if used is preferably present at 1 to 60%, most preferably 10 to 30%, based on the weight of wax. An organic liquid, for example liquid paraffin or a naphthenic oil, can be used alternatively or additionally if it is compatible with the blend of active material and waxy silicone.

The waxy silicone material can alternatively be a blend of a polysiloxane fluid, for example a linear polydiorganosiloxane as described above, with an organic wax. The organic wax can for example be microcrystalline wax, paraffin wax or a mixture thereof, a long chain fatty acid or a waxy ester thereof such as a triglyceride, for example glyceryl tristearate, a monoester such as octadecyl hexadecanoate, a diester such as ethylene glycol distearate or a tetraester such as pentaeryhthritol tetrastearate, or a long chain fatty alcohol, a long chain fatty amine, a long chain fatty amide, an ethoxylated fatty acid or fatty alcohol, a long chain alkyl phenol or polyethylene wax. In general the long chain of the fatty acid, alcohol, amine or amide is an alkyl group of at least 12 and preferably at least 16 carbon atoms. The waxy silicone material blend of polysiloxane fluid and organic wax is preferably a solid of melting point in the range 10-200° C. The polysiloxane fluid can be used at up to 100% or even higher, based on the organic wax, but is preferably present at 1 to 60%, most preferably 10 to 30%, based on the weight of wax.

The weight ratio of waxy silicone material (including any liquid silicone used) to active material is generally in the range 1:5 to 20:1. This ratio will vary according to the nature of the active material; for example a highly volatile perfume mix may need more wax to give controlled delivery than a sunscreen or less volatile flavor or fragrance.

The emulsion can conveniently be formed by melting the blend of active material and waxy silicone, and liquid silicone if used, and emulsifying it in the aqueous continuous phase using at least an esterquat surfactant. The emulsion can alternatively be made by emulsifying the waxy silicone in the aqueous continuous phase, using at least an esterquat surfactant, in the absence of the active material. The active material, for example a fragrance or sunscreen composition is post-added to the emulsion, which is then heated above the melting point of the waxy cyclopolysiloxane and left standing at this temperature, preferably for a period of at least 10 minutes, for example 30-60 minutes, allowing the active material to diffuse within the hydrophobic waxy polysiloxane droplet.

The cationic surfactant is preferably an esterquat quaternary ammonium materials containing at least one ester linking group in the quaternary ammonium molecule. Preferred esterquats comprise a quaternary ammonium moiety containing one, two or three higher molecular weight groups, for example of 12 to 22 carbon atoms, containing at least one ester linkage, and three, two or one lower molecular weight alkyl groups. Such esterquats are described in U.S. Pat. No. 4,137,180, for example 1,2-bis(hardened tallowoyloxy)-3-trimethylammonium-propane chloride and/or 1-hardened tallowoyloxy-2-hydroxy-3-trimethylammonium-propane chloride, di(tallowoyloxyethyl)dimethyl ammonium chloride, or di(tallowoyloxyethyl)methyl hydroxyethyl methosulphate. We have found that use of esterquat surfactants in the emulsion of active material and waxy siloxane material can reduce the level of silicone wax needed to give controlled delivery, for example controlled delivery of fragrance in a rinse cycle softener used in home laundry. For example the ratio of silicone wax to fragrance required to give optimum controlled delivery of fragrance may be halved. Esterquats containing at least two ester linking groups in the quaternary ammonium molecule are particularly effective.

The cationic surfactant can alternatively be a quaternary ammonium material containing at least two alkyl chains each having at least 12 carbon atoms, preferably 12 to 22 carbon atoms, for example a dimethyl di(long chain alkyl)ammonium chloride.

In one preferred form of the invention the continuous phase of the emulsion comprises an aqueous solution of concentration at least 0.1 molar of a salt capable of ionic disassociation in water. We have found that the high ionic strength of the continuous phase increases the partition coefficient between the continuous phase and the waxy silicone matrix, so that the active material tends to stay in the wax phase rather than diffusing into the continuous phase.

The salt present in the continuous phase can for example be an alkali metal, ammonium or alkaline earth metal salt. It can be an inorganic salt such as a chloride, sulphate or phosphate but is preferably an organic salt, particularly a carboxylate such as an acetate or propionate, for example sodium acetate. The salt can be a polyelectrolyte. The salt preferably has no surfactant properties; in general, the salt should not contain any organic group which has a chain of 8 or more carbon atoms unsubstituted by polar groups. The concentration of the salt in the aqueous solution which forms the continuous phase of the emulsion is preferably at least 0.1 M (molar), more preferably at least 1 M, up to 5 or 10 M. In the case of a salt of a polyelectrolyte, the concentration is measured as the concentration of the non-polymeric ion of the salt.

The emulsion can additionally comprise another surfactant which is not an esterquat. The additional surfactant can be a cationic, anionic, nonionic or amphoteric surfactant. Cationic surfactants may be preferred as the additional surfactant because of their propensity to adsorb at surfaces, in particular onto fabrics.

The composition for controlled release of active material can be produced in various forms. For example in the case of fragrances, for some applications the controlled release fragrance emulsion can simply be mixed with a cleaning or cosmetic composition. The controlled release fragrance composition can be produced in particulate form, which may be preferred for blending with a solid cleaning product such as a powder detergent. An emulsion as described above can be deposited on a particulate solid carrier or can be spray dried. Examples of suitable solid carriers include soda ash (sodium carbonate), zeolites and other aluminosilicates or silicates, for example magnesium silicate, phosphates, for example powdered or granular sodium tripolyphosphate, sodium sulphate, sodium carbonate, sodium perborate, cellulose derivatives such as sodium carboxymethylcellulose, granulated or native starch and clay.

The carrier particles are preferably mixed while being treated in a granulation process which produces agglomerated granules. In one preferred process, the particles are agitated in a vertical, continuous high shear mixer in which an emulsion of the composition for controlled release of fragrance is sprayed onto the particles. If needed to improve the granulation process, the emulsion can be diluted with for example water, molten polyethylene glycol or an aqueous solution of polyelectrolyte. One example of such a mixer is a Flexomix mixer supplied by Hosokawa Schugi. The spraying and mixing produces agglomerated granules. Alternative mixers may be used, for example horizontal mixers such as pin mixers or paddle mixers, ploughshare mixers, twin counter-rotating paddle mixers, or intensive mixers including a high shear mixing arm within a rotating cylindrical vessel. Alternatively a fluid bed coating procedure can be used. Advantageously a process of granulation by mixing can be followed by cooling and drying in a continuous fluid bed.

Granules produced from an emulsion whose continuous phase is an aqueous solution of a polyelectrolyte salt may be post-coated with a material, for example a polymer, of opposite charge to the polyelectrolyte. If the salt in the continuous phase of the emulsion is a cationic polyelectrolyte salt, for example, the granules can be post-coated with an anionic polyelectrolyte. Such post-coating may improve the deposition of the perfume on a fabric which is subsequently washed or rinsed in the presence of the granules.

Granules with a perfume content of up to 15%, for example 8-12%, by weight can readily be produced by the process of the invention. An emulsion according to the invention can have a perfume content of up to 30 or 40% or even 50% by weight.

In an alternative process according to the invention for producing a fragrant powdered cleaning product, the emulsion described above is deposited on a powdered cleaning product, for example by spraying the emulsion onto a detergent powder composition, and is subsequently dried.

In a process according to the invention for producing a fragrant liquid cleaning product, for example a liquid laundry detergent, household cleaning product, fabric softener, hair shampoo or soap or shower gel for personal washing, or a roll-on or spray deodorant, an emulsion as described above is dispersed in the liquid cleaning product, or the blend of a fragrance composition and waxy siloxane material can be emulsified in the liquid cleaning product. When producing a cleaning product or personal care product in gel form, for example a stick deodorant, an emulsion as described above can be incorporated in the product when it is in liquid form, or the blend of a fragrance composition, wax and liquid silicone can be emulsified in the product when it is in liquid form, before it is gelled. A tumble drier sheet can be produced by impregnating a textile material with an emulsion as described above.

A textile treatment composition according to the present invention may be any composition for treating fibrous material including leather or paper as well as natural or synthetic fibre textile materials such as woven, nonwoven or knitted fabrics. In addition to tumble drier sheets mentioned above, release of fragrance can be controlled from fabric softeners, fabric and garment finishing compositions, leather finishing compositions or paper tissue for personal or household cleaning use. Release of drugs (pharmaceutically active materials) such as menthol or camphor can be controlled from handkerchiefs or tissues.

The delayed release fragrance emulsion of the invention can alternatively be applied as a coating to a substrate to give sustained release of perfume from the surface.

Where the active material is a sunscreen composition, the controlled release composition can for example be prepared in the form of an emulsion as described above. The emulsion can then be mixed into a skin care or other cosmetic composition, or into a fabric care composition. For example, a lipophilic screening agent(s) can be present in a skin care composition according to the invention at 0.5 to 30%, preferably from 0.5 to 20%, of the total weight of the composition. A hydrophilic screening agent(s) can be present in the skin care composition at 0.1 to 20%, preferably from 0.2 to 10%, by weight of the composition. The skin care composition can additionally contain pigments, preferably nanopigments (average primary particle size: generally between 5 nm and 100 nm, preferably between 10 and 50 nm) of coated or uncoated metal oxides, such as nanopigments of titanium oxide (amorphous or crystallized in rutile and/or anatase form), of iron oxide, of zinc oxide, of zirconium oxide or of cerium oxide, which are all photoprotective agents which act by physically blocking (reflection and/or scattering) UV radiation. Examples of coating agents for the metal oxide pigments are alumina and/or aluminum stearate, and silicones.

The advantages of incorporating a UV absorbing sunscreen in a laundry detergent are described in a paper by M. Schaumann et al entitled “Sun Protection via Laundry Products” presented at 5^{th} World Conference on Detergents, 13-17 Oct. 2002 in Montreux, Switzerland. The UV transmittance of a fabric is reduced by washing in such a detergent. It is desirable that the sunscreen should survive storage in the cleaning composition and should not be lost in the aqueous phase during the washing cycle so that it is deposited on the fabric. Blending the sunscreen with a waxy silicone and emulsifying according to the invention increases the proportion of sunscreen deposited on the fabric.

### EXAMPLES

The invention is illustrated by the following Examples:

### Example 1

A silicone wax was prepared by reacting an olefin mixture (C26-C45 alkyl chain length) with tetramethylcyclotetrasiloxane to form a cyclic poly(methylalkylsiloxane) wax.

An aqueous thickening solution was prepared by dispersing 3.51 g xanthan gum (Keltrol RD (Trade Mark) and 9.66 g hydroxyethylcellulose (Natrosol 250 LR(Trade Mark)) in 382.64 g of demineralised water and adding. 0.69 g sorbic acid, 1.36 g benzoic acid and 3.15 g of a 10% solution of sulfuric acid.

59.5 g of the thickening solution, 30 g of esterquat cationic surfactant (Tetranyl L1/90 (Trade Mark)), 33 g of Arquad 16-29 (Trade Mark; a cationic surfactant which is not an esterquat) and 64 g of the cyclic poly(methylalkylsiloxane) wax were loaded in a stirred reactor and heated to 80° C. to form an oil-in-water emulsion. 15.8 g of a highly volatile perfume mix was then added to the emulsion. After 20 minutes, the heating was stopped. 37.5 g of the thickening solution followed by 129 g of demineralised water were finally added. The product was an emulsion of a blend of perfume and wax in weight ratio 1:4.

### Comparative Example 1

47 g of the thickening solution, 4.5 g of Volpo (Trade Mark) S2 and 3.9 g of Volpo S20 ethoxylated stearyl alcohol nonionic surfactants, 14.3 g of sodium chloride, 26 g of Arquad 16-29 and 57.4 g of the silicone wax of Example 1 were loaded in a stirred reactor and heated to 80° C. 14.42 g of the highly volatile perfume mix was then added. After 20 minutes, the heating was stopped. 31 g of the thickening solution followed by 104 g of demineralised water were finally added to form an emulsion of a blend of perfume and wax in weight ratio 1:4.

### Comparative Example 2

62.6 g of the thickening solution, 6 g of Volpo S2, 5 g of Volpo S20, 18.6 g of sodium chloride, 34.5 g of Arquad 16-29 and 84.5 g of silicone wax were loaded in a stirred reactor and heated to 80° C. 11.08 g of the highly volatile perfume mix was then added. After 20 minutes, the heating was stopped. 41 g of the thickening solution followed by 137 g of demineralised water were finally added to form an emulsion of a blend of perfume and wax in weight ratio 1:7.6.

The Emulsion of Example 1 and the emulsions of Comparative Examples 1 and 2 were each incorporated in a rinse cycle fabric softener at a level corresponding to 3% perfume in the softener. They were evaluated in a Miele 934 front loading washing machine, loaded with 4 terry towels and 5 pillowcases. For the main wash at 40° C., 30 g of a detergent powder and 17 litres of water were used. The softener was incorporated in the rinse. After line drying, the odor of the towels was followed for eight days.

Comparative Example 2 was found to give more intense odor during the 8 days of testing than Comparative Example 1, demonstrating that in the absence of esterquat, a 1/7.6 perfume/wax provides a better control of fragrance release than the 1/4 ratio. Example 1 however gave a more sustained odor over the 8 days than Comparative Example 2. This demonstrates that the use of esterquats allows one to reduce significantly the level of silicone wax needed to control the release of perfume.

1. A composition for controlling the release of an active material, selected from fragrances, sunscreens, vitamins, drugs, biocides, pest repellents, catalysts and cooling agents, from a cleaning composition, personal care product, household care product or textile treatment composition, comprising a blend of the active material and a waxy silicone material, wherein the blend of active material and waxy silicone material is present as the disperse phase of an oil-in-water emulsion comprising a cationic surfactant which is an esterquat quaternary ammonium material containing at least one ester linking group in the quaternary ammonium molecule or a cationic surfactant which is a quaternary ammonium material containing at least two alkyl chains each having at least 12 carbon atoms.

2. A composition according to claim 1 wherein the waxy silicone material is a polysiloxane in which at least 20% of the silicon atoms have an alkyl substituent having 16 to 100 carbon atoms.

3. A composition according to claim 1 wherein the waxy silicone and the active material are blended with a liquid silicone compatible with the waxy silicone.

4. A composition according to claim 1 wherein the waxy silicone material is a blend of a polysiloxane fluid with an organic wax.

5. A composition according to claim 1, wherein the continuous phase of the said oil-in-water emulsion comprises an aqueous solution of concentration at least 0.1 molar of a salt capable of ionic disassociation in water.

6. A composition according to claim 1, wherein the cationic surfactant is an esterquat quaternary ammonium material containing one, two or three groups of 12 to 22 carbon atoms containing at least one ester linkage, and three, two or one lower molecular weight alkyl groups.

7. A composition according to claim 1, wherein the cationic surfactant is an esterquat quaternary ammonium material containing at least two ester linking groups in the quaternary ammonium molecule.

8. A composition according to claim 1, wherein the cationic surfactant is an esterquat and the emulsion additionally comprises another cationic surfactant which is not an esterquat or a non-ionic surfactant.

9. A process for controlling the release of an active material, selected from fragrances, sunscreens, vitamins, drugs, biocides, pest repellents, catalysts and cooling agents, from a cleaning composition, personal care product, household care product or textile treatment composition by blending the active material and a waxy silicone material before adding the active material to the cleaning composition, personal care product, household care product or textile treatment composition, wherein the waxy silicone material and the active material are emulsified with water and a cationic surfactant which is an esterquat quaternary ammonium material containing at least one ester linking group in the quaternary ammonium molecule or a cationic surfactant which is a quaternary ammonium material containing at least two alkyl chains each having at least 12 carbon atoms to form a water-in-oil emulsion.
